(19) United States
(12) Patent Application Publication
(10) Pub. No.: US 2017/0270686 A1
(43) Pub. Date: Sep. 21, 2017

(54) Use of Camera on Mobile Device to Extract Measurements From Garments

(71) Applicant: Jessica V. Couch, Durham, NC (US)

(72) Inventor: Jessica V. Couch, Durham, NC (US)

(21) Appl. No.: 15/462,940

(22) Filed: Mar. 20, 2017

Related U.S. Application Data
(60) Provisional application No. 62/310,695, filed on Mar. 19, 2016.

(51) Int. Cl. G06T 7/62; G06Q 30/06; H04N 5/232; G06K 9/62; G06K 9/22

(52) U.S. Cl. CPC G06T 7/62; G06K 9/6202; G06K 9/228; H04N 5/23216; H04N 5/23293; G06Q 30/0643; G06T 2210/16

(57) ABSTRACT

This document presents a system and method for generating accurate, specific measurements of garments through the use of a camera associated with a mobile device and transmitting the measurements to relevant third party applications. The camera may capture an image of the garment and based upon metrics associated with the mobile device and camera, calculate the measurements and/or sizing of the garment captured in the camera image. The information may then be transmitted to a third party to assist in the creation of a personalized catalogue of garments that are less likely to be returned by a user for reasons of poor fit.

This Non-Provisional application claims under 35 U.S.C. §120, the benefit of the Provisional Application 62/310,695, filed Mar. 3, 2016, Titled “Use of Camera on Mobile Device to Extract Measurements From Garments” which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The multi-billion dollar apparel industry provides ready-to-wear garments in a number of sizes to attempt to satisfy a large percentage of customers as to fit and styling. Regardless of the number of sizes, these garments are manufactured on a “best guess” basis as to sizing. Individual customers are generally aware of sizes that may fit, but still must try on garments to be sure of the fit. This need often creates a problem for customers shopping online.

Often the fit is incorrect for any of a number of reasons, and the garments are returned by the purchaser who shops online. These returns are an issue for the e-commerce industry as they may not be able to be sold again as new garments, or may have other issues such as damage occurring in shipment or handling. Returns of garments for fit issues continue to plague the apparel industry. Returns account for millions of dollars lost for apparel companies annually. One out of every three garments sold online gets returned. The apparel industry is therefore looking for ways to minimize these issues and, by extension, the return of garments due to issues of fit.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of using a mobile device with an integral camera capturing a garment image consistent with certain embodiments of the present invention.

FIG. 2 is a view of selecting a similar garment type consistent with certain embodiments of the present invention.

FIG. 3 is a view of user selection of the metric settings for use consistent with certain embodiments of the present invention.

FIG. 4 is a view of one or more preferred shopping venues consistent with certain embodiments of the present invention.

FIG. 5 is a view of a personalized catalogue of garments for selection consistent with certain embodiments of the present invention.

FIG. 6 is an operational flow diagram for image capture and automatic sizing consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Returns continue to plague the apparel industry accounting for billions of dollars each year. A large percentage of returns are based solely on fit issues. Understanding fit in the virtual world is difficult. Current technologies cross reference user input data (physical measurements) of garments and or body parts with existing measurements of garments presented by an online retailer. Although current technologies facilitate such comparisons, current technologies do not incorporate a mobile solution for capturing physical measurement data. This system presents a method to capture specific physical measurement data through use of a smartphone camera.

The system herein described provides a system and method for generating accurate, specific measurements of garments through the use of a camera integral to a mobile device and exchanging the data with third party databases to provide users with unique shopping experiences. A touchscreen associated with the mobile device provides an interface to display image data and accept user input with respect to the image. The user input includes a plurality of data points based on user touches on the interface with respect to the image. Alternatively, the mobile device may be provided by the user with a distance from the mobile device to the garment captured in an image by the camera. The mobile device may use the relative size of the mobile device and the resolution in pixels of the camera to calculate the sizing of the garment captured in the image.

The mobile device includes a processor with memory to store instruction and data and to process user input from the touchscreen interface. The processor will have a software module that is operative to instruct a user on proper screen interactions to guide the calculation of measurements of a garment captured in a camera image. The software module is further operative to convert the calculated measurements into metrics such as inches, centimeters, millimeters, or any other preferred system of metrics. The determined measurements may then be exported to 3^{rd} party technologies requesting measurement data for garments, as well as being provided to the user of the mobile device.

The purpose of this mobile interaction is to replace human input techniques, cut down on human error and extract measurements from garments in order to compare garment-sizing data through existing virtual applications. In addition to one or more camera images, sensors installed in a mobile device may be utilized to capture measurement data of garment laid flat or hung on hanger.

The system may provide a software algorithm to analyze the captured image of the garment to perform garment matching and attempt to recognize the garment captured in the image. The system may also provide the calculated measurements and/or sizing to permit the garment matching software algorithm to recognize garment characteristics associated with age, gender, styles, color, and other elements of the garment being analyzed.

In an embodiment, a garment matching software algorithm may be used in conjunction with identification of the garment captured in the image to provide measurement comparison with the garment and other garments selected by a user. The garment comparison may permit a user to have greater confidence that other garments selected by the user from third party sources may have the same approximate size and/or measurements as the garment captured in the image. The garment comparison function may permit a user to make better sizing selections from images in an online or other catalogue when involved in virtual shopping activities.

In an embodiment, the system may provide an algorithm to save certain garment images as reference items. These images may be recalled from storage and used for base measurement comparison of garments in a virtual catalogue. Additionally, the measurement comparison algorithm may be used to find an unknown measurement of a photographed garment, providing a user with some assurance as to the measurement or sizing of the photographed garment.

In an embodiment, the mobile device may contain a depth sensor capability to scan and calculate measurements of garments, shoes, and accessories. The depth scanner or sensor may provide three-dimensional measurement data to provide greater understanding to a user of the physical size of a garment, shoe, or accessory prior to ordering any such item.

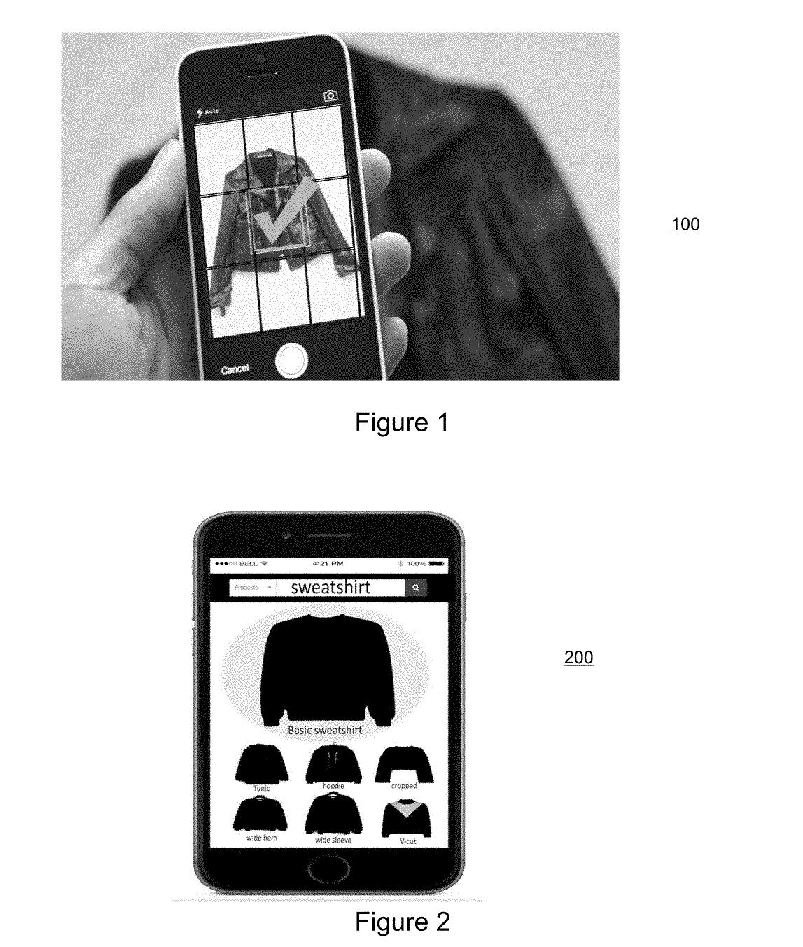

Turning now to FIG. 1, this figure presents a view of using a mobile device with an integral camera capturing a garment image consistent with certain embodiments of the present invention 100. In an exemplary embodiment, a user may initiate a software application on a network enabled mobile device, such as a tablet, smart phone, network computer, or other device having a camera, processor, and network connectivity. The software application may connect with the camera associated with the device. The user may focus the image of a garment, either lying on a flat surface or hanging freely on an individual hanger, to place the entire garment within the field of view of the camera. The software application may provide a visual indicator that the entire garment is properly positioned to capture the image of the garment.

The user may then select the camera toggle to capture the image of the garment. The user may be requested to input the distance from the camera to the garment location, or the software application may have alternative means to determine the distance from the mobile device containing the camera to the location of the garment. The software application has access to the mobile device camera specification, such that the software application knows the resolution of the camera in pixels as well as the size of the mobile device in either metric or English units. From the information about the size of the mobile device, the resolution of the camera image, and the distance from the camera to the garment, the software application may calculate the physical size of the garment captured in the image. This information is stored within the electronic memory associated with the mobile device.

Turning now to FIG. 2, this figure presents a view of selecting a similar garment type consistent with certain embodiments of the present invention 200. In an exemplary embodiment, the figure presents the captured image of the garment in which the user has an interest. To optimize the sizing determination, the user may enter the type of garment that is captured in the image. Upon entry of the garment type, the user may be presented with a plurality of garment silhouettes that are common for the type of garment captured in the image. The user may select the silhouette that is most similar to the garment, and the software application utilizes this information to optimize the sizing determination of the garment.

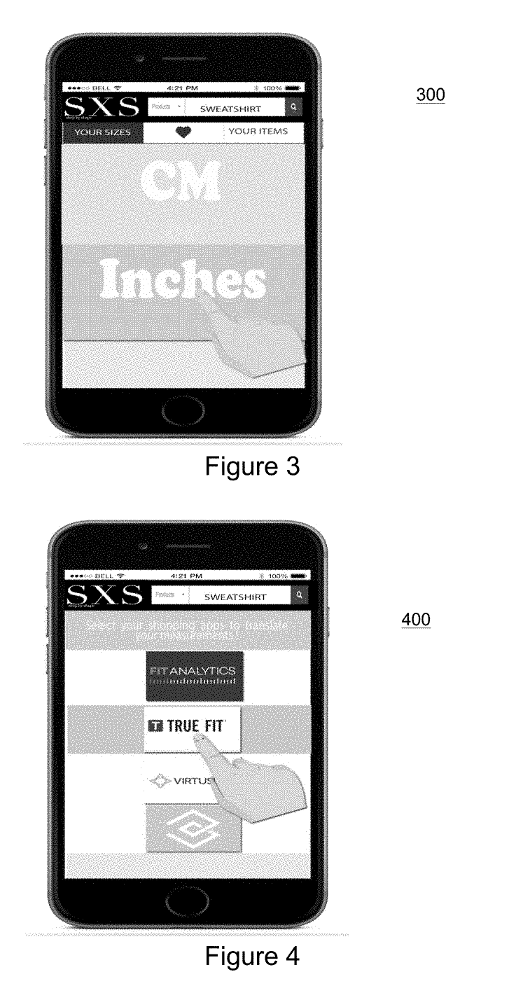

Turning now to FIG. 3, this figure presents a view of user selection of the metric settings for use consistent with certain embodiments of the present invention 300. In an exemplary embodiment, a user may then be presented with a selection of numbering systems. The numbering systems are presented to permit the user to convert the determined sizing measurements into the metrics most preferred by the user. In a non-limiting example, the user may be presented with a selection of metric system or English system metrics in which to report the measurements of the garment captured in the image. In this manner, the user may have the sizing reported by the software application in metrics that are most useful to the user in selecting garments with which the user is most familiar. Alternatively, the user may select a metric system that is most useful for the shopping experience being pursued by the user.

Turning now to FIG. 4, this figure presents a view of one or more preferred shopping venues consistent with certain embodiments of the present invention. In an exemplary embodiment, the measurements for the garment the user has selected may be transmitted to an additional, third-party application or technological platform to permit the third-party to understand the needs and desires of the user 400. In this exemplary embodiment, the measurement data collected may be sent to various third parties who require measurement input data from users. Currently, many third party garment providers rely on users to input the data by measuring themselves and may be subject to human error. Therefore, a user may utilize the camera to take the measurements one time and upload them to several different third parties and in turn get a size comparison from many brands.

As a non-limiting example, the user may specify one or a group of online store(s) that may be preferred shopping destinations. If the specified online store has access to a third-party technology platform for determining sizing of garments, and if the online store utilizes the third-party technology, the third-party technology will be made available to the user through the software application installed and operational on the mobile device. This interaction may facilitate proper sizing and reduce the possibility that the user will receive the wrong size garment from the online store, even though the user has no physical interaction with the garments being selected from the online store. Additionally, the measurement and sizing information calculated from the image of the garment captured by the camera will be stored in an electronic database on the mobile device for later retrieval and utilization. This data may be retrieved and transmitted to a group of third party garment suppliers and the user may receive sizing information from each third party garment supplier in the garment supplier's sizing format. This data from each member of the group of third party suppliers permits a user to compare sizes from each brand marketed by the group of third party suppliers to permit an equivalence comparison for garments of interest to the user.

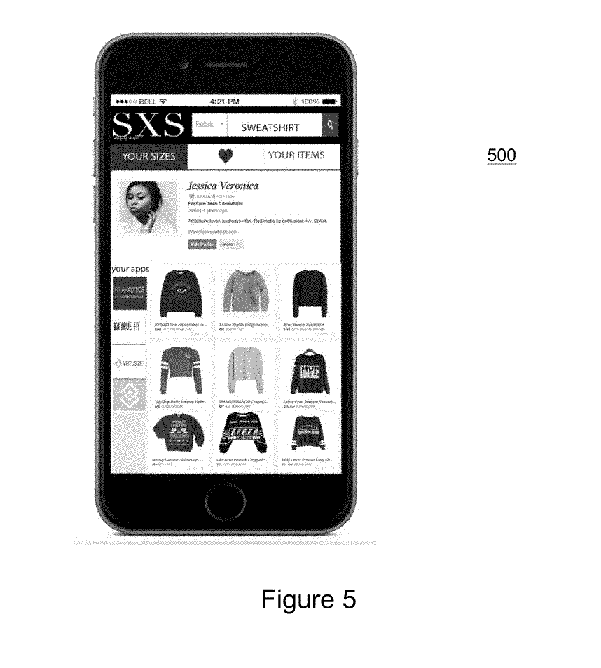

Turning now to FIG. 5, this figure presents a view of a personalized catalogue of garments for selection consistent with certain embodiments of the present invention. In an exemplary embodiment, upon transmission of the measurement and sizing information to a store or other shopping venue through a third-party application or technology platform, the third party may utilize this data to create a selection of garments personalized for the user 500. The user may then be presented with the personalized selection of garments to permit the user to shop a catalogue of garments that meet the transmitted measurements and/or sizing, within reasonable tolerances. Once again, the personalized selection of garments will be optimized for the sizing and/or measurement transmitted from the user and, thus, will be far less likely to be returned, once purchased, for reasons of poor fit.

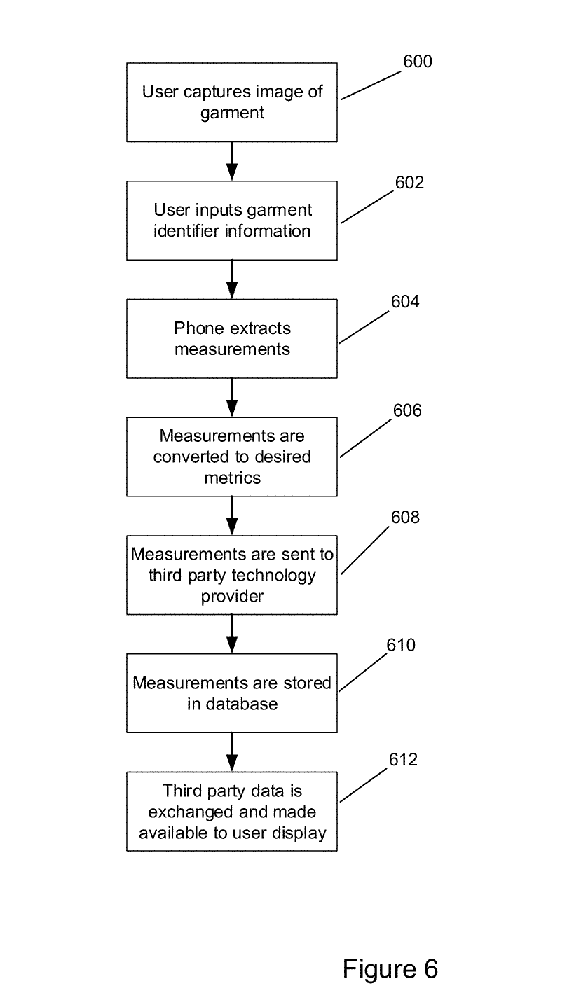

Turning now to FIG. 6, this figure presents an operational flow diagram for image capture and automatic sizing consistent with certain embodiments of the present invention. In this embodiment, the user toggles camera over selected garment, where the garment is on a solid contrasting background, or placed on a hook in front of a solid contrasting background. The user may adjust the image of the garment visible on the camera screen accordingly to ensure accurate measurements for the garment captured in the camera image. The mobile device may then calibrate vertical and horizontal distance of the mobile device in relation to the garment. The user then may toggle the camera to capture the image 600.

In an embodiment, the user may be instructed by the software application on the mobile device to select relevant points/lines on the image of garment as it relates to the measurements needed to obtain information on fit comparisons of the garment. The software application captures the user input to include a plurality of data points based on user touches on the interface with respect to the image 602. In this alternative embodiment, capturing this data may require the user to tap points and drag along the edges of the extracted garment image. However, input by the user is not a requirement of the measurement process. The measurements of the garment in the captured image may then be calculated based upon the horizontal distance to the garment, the relative size of the mobile device, and the resolution, in pixels, of the camera used to capture the image 604, with or without the use of input user information, and extract the measurements associated with the garment captured in the image.

In a preferred embodiment, measurement and sizing data is extracted and made available to the user in various metrics, where the measurements may be converted to desired metrics, such as, in a non-limiting example, English system units, metric system units, US sizing, European sizing, or any other sizing system or measurement system the user prefers 606. The mobile device automatically stores information of the user for future use, and this information may be transmitted to a system server that is cross-referenced against the user identifier to be stored for future recall and utilization.

In this preferred embodiment, the server associated with the sizing system that is in communication with the user's mobile device may automatically store information about the user's selected garments. The server may then provide information to third party databases requiring measurements for data comparison between garments and other merchandise maintained in the third party databases 608. The third party database may then be populated by obtained measurements from mobile image capture from the mobile device 610. Clothing items correlating to the stored measurements and/or sizing sent out to third parties may be selected from the third party databases to populate a catalogue of garments and other items that are personalized for the user. User now has access to multiple third party selections in one comprehensive, personalized catalogue 612.

While certain illustrative embodiments have been described, it is evident that many alternatives, modifications, permutations and variations will become apparent to those skilled in the art in light of the foregoing description.

I claim:

1. A clothing measurement and sizing system, comprising:
a mobile device having a camera;
a software module operative to determine the distance from said camera to a garment, where the garment is centered within the view from said camera;
a software module operative to determine the resolution of the camera in pixels and the physical dimensions of the mobile device;
the camera active to capture an image of the garment on direction of a user;
calculating the physical size of the garment from the captured image.

2. The system of claim 1, further comprising calculating the physical size of the garment using information about the size of the mobile device, the resolution of the camera image, and the distance of the camera to the garment.

3. The system of claim 1, where the distance from the camera to the garment may be automatically calculated by the mobile device.

4. The system of claim 1, where the distance from the camera to the garment may be input by the user.

5. The system of claim 2, where the calculated physical size of the garment is stored in a database.

6. The system of claim 1, further comprising calculating measurements of the garment where the measurements may be converted to desired sizing, in English system units, metric system units, US sizing, European sizing, or any other sizing system the user prefers.

7. The system of claim 6, further comprising transmitting the calculated garment measurements to a third party technology provider.

8. The system of claim 7, further comprising selecting from a third party technology provider, clothing items correlating to the calculated measurements of the garment to populate a catalogue of garments and other items that are personalized for the user.

9. A clothing measurement and sizing method, comprising:
a mobile device having a camera;
determining the distance from said camera to a garment, where the garment is centered within the view from said camera;
determining the resolution of the camera in pixels and the physical dimensions of the mobile device;
capturing an image of the garment in the camera on direction of a user;
storing the captured image in an image database; and
calculating the physical size of the garment from the captured image.

10. The method of claim 9, further comprising calculating the physical size of the garment using information about the size of the mobile device, the resolution of the camera image, and the distance of the camera to the garment.

11. The method of claim 9, where the distance from the camera to the garment may be automatically calculated by the mobile device.

12. The method of claim 9, where the distance from the camera to the garment may be input by the user.

13. The method of claim 10, where the calculated physical size of the garment is stored in a database.

14. The method of claim 9, further comprising calculating measurements of the garment where the measurements may be converted to desired sizing, in English system units, metric system units, US sizing, European sizing, or any other sizing system the user prefers.

15. The method of claim 14, further comprising transmitting the calculated garment measurements to a third party technology provider.

16. The method of claim 15, further comprising selecting from a third party technology provider, clothing items correlating to the calculated measurements of the garment to populate a catalogue of garments and other items that are personalized for the user.
